(19) United States
(12) Patent Application Publication
(10) Pub. No.: US 2025/0234862 A1
(43) Pub. Date: Jul. 24, 2025

(54) FUNGICIDAL COMPOSITION FOR PREVENTING AND CONTROLLING ROOT ROT DISEASES IN CROPS CAUSED BY FUSARIUM SPP.

(71) Applicant: Institute Of Plant Protection And Agro-Products Safety, Anhui Academy Of Agricultural Sciences, HEFEI (CN)

(72) Inventors: WEI ZHAO, HEFEI (CN); RENDE QI, HEFEI (CN); YUANKAI CHI, HEFEI (CN); AMEI XU, HEFEI (CN); TAO WANG, HEFEI (CN); SHUN CAO, HEFEI (CN); YANQIU HE, HEFEI (CN)

(21) Appl. No.: 18/785,277

(22) Filed: Jul. 26, 2024

(30) Foreign Application Priority Data
Jan. 23, 2024 (CN) 202410096796.9

(51) Int. Cl. A01N 43/40; A01N 43/653; A01P 3/00

(52) U.S. Cl. CPC A01N 43/40; A01N 43/653; A01P 3/00

(57) ABSTRACT

A fungicidal composition for preventing and controlling root rot diseases in crops caused by Fusarium spp. is disclosed. The active ingredient is composed of cyclobutrifluram and ipconazole. An appropriate amount of fungicidal additives are added to the composition to prepare a seed coating dosage form and other dosage forms used for preventing and controlling root rot diseases. The present disclosure has a higher control effect on fungal diseases of crops, has a significant synergistic effect between the two agents, and achieves comprehensive disease prevention and control of multiple diseases; By means of seed coating, diseases can be effectively prevented, so as to achieve the effect of preventing diseases and healthy seedlings, reduce the threat of diseases at a later stage, significantly reduce the application amount of pesticides at a later stage, effectively reduce ecological damage and environmental pollution, and simultaneously improve the yield and quality of crops.

### TECHNICAL FIELD

This disclosure belongs to the field of agricultural fungicides and specifically relates to a fungicidal composition formed by different ratios of cyclobutrifluram and ipconazole. By adding an appropriate amount of additives, this composition is formulated into seed coating agents and other commonly used dosage forms for crop disease prevention and control. It effectively prevents and controls root rot diseases in crops caused by Fusarium spp., while also providing protection against common fungal diseases and nematode-induced disorders.

### BACKGROUND ART

Fusarium spp. is a common and highly harmful pathogen that causes plant diseases that can cause diseases in various parts of plants, such as wheat scab, corn ear rot, root rot, wilt, wheat stem base rot, soybean sudden death syndrome caused by Fusarium, and more. Among these, the root and stem base diseases caused by Fusarium are one of the stubborn problems in plant growth, often referred to as the “cancer” of plants, which are difficult to control. Fusarium can survive for a long time in soil and on residual plant bodies. When plants are sown, under suitable conditions, they can be infected. Fusarium infects from the roots, with a long incubation period. Once symptoms appear, it is difficult to save the plant, leading to wilting and death. Moreover, during infection, Fusarium produces a large amount of toxins, causing more severe damage to plants and indirect poisoning to humans and animals. In recent years, due to changes in farming practices such as straw returning to the field and minimum-tillage and no-Tillage, the residual amount of Fusarium in the field has been increasing, leading to a gradual increase in the occurrence area of diseases.

Wheat is one of the most important food crops worldwide, and wheat stem base rot caused by Fusarium spp. is one of the main diseases affecting wheat. The main pathogens include Fusarium pseudogramineaqum, Fusarium graminearum, Fusarium culmorum, Fusarium proliferatum, Fusarium acuminatum, Fusarium oxysporum, etc., among which Fusarium pseudogramineaqum is the most common and virulent pathogen causing wheat stem base rot. The disease incidence rate in affected fields is 5%-10%, and in heavily diseased fields, it can reach about 30%, with yield losses of 10%-40%, and the susceptible varieties may even lead to complete crop failure. Additionally, during the infection process, Fusarium can produce mycotoxins such as vomitoxin, namely deoxynivaleno (DON), which is a Class III carcinogen, and when consumed by humans and animals, it can cause food poisoning, seriously endangering their health. The disease can invade the plant before winter, lying dormant in the wheat seedlings as temperatures drop. In the early stage of pathogen invasion, plants have no obvious symptoms. Early in the spring, as temperatures rise and under suitable weather conditions, the pathogen rapidly spreads, eventually leading to the death of the entire plant. Furthermore, due to the variety of soil-borne diseases in wheat (such as Grain withering, total erosion, stem base rot, root rot, etc) and complex pathogens often occurring together in production, it significantly affects wheat yield and quality.

Soybeans and soy products are one of the main sources of traditional edible vegetable oils and proteins in my country. With the development of the national economy and the improvement of residents' living standards, the demand for soybeans is increasing. In particular, the general public's pursuit of health has led to a rapid increase in the number of direct consumptions of soy products and vegetable oils. However, root and stem base diseases in soybean production are also stubborn problems, severely restricting the increase in soybean yield and improvement in quality. Common root and stem base diseases in soybean production include various types of Fusarium root rot caused by different species of Fusarium spp., soybean stem blight caused by Diaporthe spp., red carbon rot caused by Calonectria ilicicola, carbon rot caused by Macrophomina phaseolina, rhizoctonia disease caused by Rhizoctonia solani, southern blight caused by Sclerotium rolfsii, etc. Soybean root rot caused by Fusarium spp. is the most common and harmful disease in soybean production, among which sudden death syndrome caused by a complex of Fusarium solani strains is a persistent problem in North American soybeans, leading to widespread death or even total crop failure. Currently, in major soybean growing areas in China, root rot caused by Fusarium solani is showing a trend of widespread and frequent occurrence, with increasing pathogenicity, becoming a major obstacle to the revitalization plan of Chinese soybean industry.

Early preventive intervention is the primary means of controlling root and stem base diseases in crops, among which seed coating with efficient seed treatment agents is the most effective and economical method. However, there is a lack of seed treatment formulas on the market that are highly efficient, broad-spectrum, and relatively safe against various crop root rots. The common fludioxonil does not have a systemic conduction effect, triazole drugs such as tebuconazole easily cause drug damage, and the use of a single drug for a long period of time and an unreasonable application mode make the pathogen easy to produce drug resistance, leading to reduced drug efficacy and disease outbreak, thus further increasing medication, forming a vicious circulation, increasing medication costs and increasing environmental pollution, which is also a difficult problem of chemical prevention and control. Therefore, developing new types of seed treatments and rationally combining pesticides with different chemical structures and mechanisms of action is an effective measure to overcome the development of resistance. It can improve performance, expand anti-disease spectrum, reduce the amount of medication per unit area, enhance prevention and control effects, and ultimately achieve the goal of improving efficiency and reducing cost.

Cyclobutrifluram is a novel succinate dehydrogenase inhibitor (SDHI) developed by Syngenta, with the molecular formula C₁₇H₁₃Cl₂F₃N₂O and its structure shown in the FIGURE below. Cyclobutrifluram has good antifungal effects on Fusarium and is also an efficient nematicide. It mainly acts on respiratory chain electron transfer complex II, blocking energy metabolism, and has protective, therapeutic, systemic, and transport effects. Therefore, it can be developed and utilized as a new agent for the control of wheat scab. The structural formula of cyclobutrifluram is as follows:

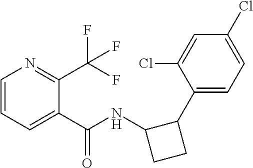 [SMILES: O=C(NC1CCC1c1ccc(Cl)cc1Cl)c1cccnc1C(F)(F)F]

Ipconazole, developed by the Japanese company KUREHA in the early 1990s, is a triazole fungicide with the chemical name (1RS,2SR,5RS;1RS,2SR,5SR)-2-(4-chlorobenzyl)-5-isopropyl-1-(1H-1,2,4-triazol-1-yl methyl)cyclopentanol and the molecular formula C₁₈H₂₄ClN₃O. Ipconazole is a broad-spectrum systemic fungicide that primarily works by inhibiting the biosynthesis of ergosterol in fungi, thereby affecting the formation of fungal cell walls and achieving the goal of inhibiting fungal growth. It possesses excellent systemic conductivity and contact protective activity, characterized by low dosage, high activity, and safety for both monocotyledonous and dicotyledonous crops, offering systemic, protective, and therapeutic effects. Ipconazole is mainly used as a seed treatment agent, known for its high efficacy and relative safety, and is widely used to control seed diseases in rice and other crops. It has shown good preventive and therapeutic effects against bakanae disease, leaf spot, and blast disease in rice. As a seed treatment agent, ipconazole is extensively applied. The structural formula of ipconazole is as follows:

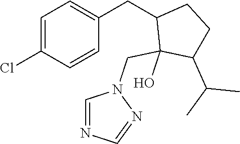 [SMILES: CC(C)C1CCC(Cc2ccc(Cl)cc2)C1(O)Cn1cncn1]

### SUMMARY

This disclosure provides two fungicides with different control mechanisms and action sites against Fusarium, the compositions formed through different ratios significantly enhances the inhibitory effect on Fusarium. The formulated seed coating agents can efficiently prevent and control root and stem base rot diseases caused by Fusarium in crops. Additionally, the synergistic formula of the two agents broadens the spectrum of disease prevention in crops, also is applicable for controlling other fungal diseases and root-knot nematode diseases, offering an efficient, low-toxicity, and broad-spectrum formula combination for the comprehensive control of crop diseases.

The technical solution of this disclosure is:

A composition formula for the prevention and control of root rot in crops caused by Fusarium is provided, wherein the fungicide consists of cyclobutrifluram and ipconazole.

The characteristic of the fungicides lies in the mass ratio of cyclobutrifluram to ipconazole being between 20:1 and 1:20. For the prevention and treatment Fusarium pseudogramineaqum causing wheat stem base rot, the mass ratio of cyclobutrifluram to ipconazole is between 3:1 and 1:1; for the prevention and control of Fusarium solani causing soybean Fusarium root rot, the mass ratio of cyclobutrifluram to ipconazole is between 3:1 and 1:5.

The active ingredient of cyclobutrifluram and ipconazole account for 1% to 80% of the total mass of the fungicidal composition. By adding an appropriate amount of agricultural fungicide additives, a seed suspension coating agent is prepared, which after seed coating can efficiently prevent and control Fusarium root rot in crops and other fungal diseases at the root and stem base. Furthermore, the composition can be formulated into suspension agents, wettable powders, microcapsules, water dispersible granules, etc., for the prevention and control of common fungal diseases in crops as well as cyst nematode diseases and root-knot nematode diseases.

By adopting the above technical solution, this disclosure has the following beneficial effects:

The disclosure reports that cyclobutrifluram has a significant preventive effect on Fusarium, and the two types of compounds possess different structural types and action sites. When combined in a certain ratio, they have a significant synergistic effect. This composition not only increases the efficacy but also expands the spectrum of disease resistance. By adding high-efficiency additives and processing them into formulations that are easy to use in production such as suspension agents, wettable powders, microcapsules, water dispersible granules, or suspension seed coating agents, the biological activity is high, the spectrum of disease prevention is increased, and it has a good control effect on common nematode and fungal diseases in crops during production. Moreover, after the synergistic combination, the total amount of medication per unit area decreases, the number of applications reduces, which reduces the cost of medication application, delays the emergence and development of pathogen drug resistance, extends the service life of each component in the fungicidal composition, and has good safety for crops, thereby achieving the economical, efficient, and environmentally friendly objectives of the disclosure.

### DETAILED DESCRIPTION OF THE EMBODIMENTS

The following provides a further explanation of the disclosure through specific embodiments.

### Embodiment 1: Indoor Toxicity Determination of Cyclobutrifluram and Ipconazole Against Fusarium pseudogramineaqum and Fusarium solani

A detailed analysis of the fungicidal properties of cyclobutrifluram and ipconazole was conducted. First, the EC₅₀ (drug safety index) of the two single compounds (hereinafter referred to as agents) was determined. According to the EC₅₀ of the two single agents, the combination ratio of the two agents was set according to the Wadley method, and based on the Wadley synergistic coefficient SR value.

The experimental targets were Fusarium pseudogramineaqum and Fusarium solani. The cyclobutrifluram and ipconazole were selected, and the PDA solid medium were selected, and the required liquid chemicals plates were prepared at about 18 ml per plate. The mycelium blocks with 5 mm diameter were prepared at the edge of pre cultured colonies using a sterilized punch, transferred to different culture media plates, and cultivated at 25° C. The experiment used the mycelial growth assay method to prepare drug containing culture media according to different treatments. The mycelium blocks with 5 mm diameter were prepared at the edge of pre cultured colonies using a sterilized punch and transferred to different culture media plates with different drug contents. The colony diameter was measured using the cross over method, and the colony diameter (mm) was measured. The growth inhibition rate was calculated using the following formula:

$$Mycelial growth inhibition rate \% = ( 1 - colony diameter in drug treatment - 5 / control colony diameter - 5 ) \times 100 \%$$

The mycelial growth inhibition rate was converted to the inhibition probability value (y), and the drug concentration was converted to the concentration logarithm (x). The concentration logarithm was used as the x-axis and the probability value was used as the y-axis to create a toxicity regression line. The toxicity regression equation of a single agent of cyclobutrifluram and ipconazole and a mixed agent of cyclobutrifluram and ipconazole against the pathogen were obtained, and the EC50 value and correlation coefficient r were calculated.

According to the Wadley method to evaluate the interaction of the mixed agent, the calculation formula is as follows:

$$E {C}_{50} ( theoretical value ) = ( a + b ) / ( a / E {C}_{50} a + b / E {C}_{50} b ) , \\ S R = E {C}_{50} ( theoretical value ) / E {C}_{50} ( actual value ) .$$

Among them, a and b are the proportions of each component in the mixed agent, and the SR value is used to analyze the mixing effect. If SR≤0.5, the mixed agent of the two drugs has an antagonistic effect; if SR=0.5-1.5, the mixed agent of the two drugs has an additive effect; if SR≥1.5, the mixed agent of the two drugs has a synergistic effect.

TABLE 1
Toxicity determination results of single and mixed agent of cyclobutrifluram
and ipconazole against wheat Fusarium pseudogramineaqum.

| | | Correlation | EC₅₀ | EC₅₀ (theoretical value) | |
|---|---|---|---|---|---|
| Proportion (P:I) | Regression equation | coefficient (r) | ppm | ppm | SR |
| Cyclobutrifluram (C) | y = 5.8273 + 1.5968x | 0.9935 | 0.3033 | | |
| Ipconazole (P) | y = 6.4539 + 1.7683x | 0.9925 | 0.1506 | | |
| 20:1 | y = 5.8255 + 1.4031x | 0.9924 | 0.258 | 0.2893 | 1.1214 |
| 7:1 | y = 5.94 + 1.461x | 0.9993 | 0.2273 | 0.2692 | 1.1843 |
| 5:1 | y = 6.0564 + 1.4556x | 0.9927 | 0.188 | 0.2595 | 1.3801 |
| 3:1 | y = 6.1891 + 1.4297x | 0.9929 | 0.1473 | 0.242 | 1.6427 |
| 1:1 | y = 6.2389 + 1.3701x | 0.9973 | 0.1247 | 0.2013 | 1.614 |
| 1:3 | y = 6.294 + 1.4338x | 0.9917 | 0.1252 | 0.1644 | 1.3131 |
| 1:7 | y = 6.1876 + 1.4444x | 0.9881 | 0.1506 | 0.1607 | 1.0672 |
| 1:20 | y = 6.1864 + 1.4932x | 0.996 | 0.1605 | 0.1543 | 0.9614 |

From the above table, it can be seen that the antifungal effects of different ratios of cyclobutrifluram and ipconazole on Fusarium pseudogramineaqum causing wheat stem base rot disease were different. The experimental results show that cyclobutrifluram and ipconazole have an additive effect in the ratio range of 20:1 to 1:20, and their ratio has a synergistic effect in the range of 3:1 to 1:1.

TABLE 2
Toxicity determination results of single and mixed agent of cyclobutrifluram
and ipconazole against soybean Fusarium solani.

| | | Correlation | EC₅₀ | EC₅₀ (theoretical value) | |
|---|---|---|---|---|---|
| Proportion (P:I) | Regression equation | coefficient (r) | ppm | ppm | SR |
| Cyclobutrifluram (C) | y = 5.5681 + 1.3424x | 0.9948 | 0.3774 | | |
| Ipconazole (P) | y = 6.4018 + 1.8869x | 0.9705 | 0.1808 | | |
| 7:1 | y = 5.8278 + 1.4768x | 0.992 | 0.2751 | 0.3322 | 1.2077 |
| 5:1 | y = 5.9791 + 1.4888x | 0.9758 | 0.22 | 0.3195 | 1.4523 |
| 3:1 | y = 6.1838 + 1.5573x | 0.9776 | 0.1737 | 0.2967 | 1.7083 |
| 1:1 | y = 6.3999 + 1.5811x | 0.9763 | 0.1302 | 0.2445 | 1.8777 |
| 1:3 | y = 6.5425 + 1.7638x | 0.9792 | 0.1335 | 0.2079 | 1.5571 |
| 1:5 | y = 6.5974 + 1.1418x | 0.9838 | 0.1206 | 0.198 | 1.6417 |
| 1:7 | y = 6.5792 + 1.8141x | 0.9871 | 0.1347 | 0.1934 | 1.4357 |

From the above table, it can be seen that the antifungal effects of different ratios of cyclobutrifluram and ipconazole on Fusarium solani causing soybean Fusarium root rot disease were different. The experimental results show that cyclobutrifluram and ipconazole have an additive effect in the ratio range of 7:1 to 1:7, and their ratio has a synergistic effect in the range of 3:1 to 1:5.

The indoor combined action test results showed that the composition of cyclobutrifluram and ipconazole had a good growth inhibition effect on Fusarium pseudogramineaqum and Fusarium solani. There was a significant additive or synergistic effect between the two components in different ratios, which increased the antifungal effect. In the present disclosure, cyclobutrifluram and ipconazole are both of low toxicity and safe for humans, animals, beneficial organisms, and the environment. Cyclobutrifluram and ipconazole belong to different types of fungicides with different modes of action. There is no cross-resistance between the two, and there are also differences in their fungicidal spectrum. The mixed use of the two components can delay the resistance of the fungi to a single agent, and increase the spectrum of disease prevention in crops at the same time, thereby achieving the purpose of both prevention and drug reduction.

### Embodiment 2: Formulation Implementation

The following examples further illustrate the disclosure, but the essence of the disclosure is not limited to these examples.

### Example 1 of Formulation Implementation

Preparation of a 20% cyclobutrifluram·ipconazole suspension seed coating agent by mass percentage:

Cyclobutrifluram: 15%; Ipconazole: 5%; Xanthan gum: 2.2%; Dispersant FS3000: 6%; Calcium lignosulfonate: 5%; Ethylene glycol: 3%; Magnesium aluminum silicate: 0.3%; Bentonite: 0.5%; Eritt anhydrous fast T: 1.5%; Silicone defoamer: 2%; Film-forming agent: 5%; Dye: 2%; Water: remainder.

Preparation method: According to the formulation, the above components (except the film-forming agent and the dye) are weighed in the proportion, added to a ball mill for ball milling for 60 min, filtered, and extracted into a dispersion tank for high-speed shearing for 3 min and fully ground by a sand mill, the diameter of solid component particles is controlled to be within 1 μm, after the grinding is finished, the mixture is stirred until uniform, and the film-forming agent and the dye are added to obtain the suspended seed coating product.

### Example 2 of Formulation Implementation

Preparation of a 22% cyclobutrifluram·ipconazole microcapsule suspension seed coating agent by mass percentage:

Cyclobutrifluram: 11%; Ipconazole: 11%; Methyl oleate: 8%; Cyclohexanone: 4%; Diphenylmethane diisocyanate: 3%; fatty amide N-Methyltaurine: 2%; Ethylenediamine: 0.5%; 1,3-Propanediol: 1.2%; Sodium methylene naphthalene sulfonate: 2%; Magnesium aluminum silicate: 3.2%; Arabic gum: 2%; Polyvinyl alcohol: 2%; Polyacrylate: 2.5%; Permanent red: 4%; Water: remainder.

Preparation method: Cyclobutrifluram and ipconazole are dissolved in solvent according to the ratio; diphenylmethane diisocyanate vinegar is added and stirred to form an oil phase. Emulsifiers and auxiliary agents are added to water and stirred evenly to obtain an aqueous phase. The aqueous phase is added to the oil phase and homogenized at high speed to form an oil-in-water emulsion. At 450 rpm, ethylenediamine is introduced to initiate interfacial polymerization, with the temperature raised to 55° C. and maintained for 3 hours to solidify into microcapsules. Sodium methylene naphthalene sulfonate, magnesium aluminum silicate, permanent red, polyvinyl alcohol, and polyacrylate are then added and mixed evenly to form the microcapsule suspension seed coating agent.

### Embodiment 3: Field Control Experiment of Cyclobutrifluram and Ipconazole on Wheat Stem Base Rot Disease

Experiments employed 20% cyclobutrifluram·ipconazole suspension seed coating agent in example 1 of formulation implementation and 45% cyclobutrifluram suspension seed coating agent, 20% ipconazole suspension seed coating agent, and 15% carbendazim·thiram suspension seed coating agent. Experimental site was located at Liu Lake Farm in Suixi County using the wheat variety “Quanmai 725”. The agent was applied to seeds at a 1:1000 ratio by weight for seed coating. Additionally, the agent was diluted into a solution, with a final volume of 1 liter of solution used to treat 100 kg of wheat seeds, which were then dried in the shade before direct planting. Disease investigations were conducted during the tillering stage and after the growth of wheat entered the jointing-booting stage (Table 3).

TABLE 3
Effects of different formulation types on the control of wheat stem base rot disease in the Field.

| | | Control efficacy investigation 50 days | | | | Control efficacy investigation 150 days | | | |
|---|---|---|---|---|---|---|---|---|---|
| | | after seeding (tillering stage) | | | | after planting (jointing-booting stage) | | | |
| | | | | | Control | | | | Control |
| | Seed | | | | effect | | | | effect |
| | coating, | | | | of | | | | of |
| | agent | | Control | | disease | | Control | | disease |
| | (g):seed | Disease | efficacy | Disease | index | Disease | efficacy | Disease | index |
| Agent treatment | (g) | rate (%) | (%) | Index | (%) | rate (%) | (%) | Index | (%) |
| 20% | 1:1000 | 1.76 | 89.27 | 0.25 | 93.56 | 7.83 | 84.12 | 2.19 | 88.79 |
| Cyclobutrifluram• | | | | | | | | | |
| Ipconazole | | | | | | | | | |
| Suspension Seed | | | | | | | | | |
| Coating Agent | | | | | | | | | |
| 45% | 1:2000 | 3.07 | 81.30 | 0.53 | 86.53 | 13.66 | 72.27 | 5.15 | 73.69 |
| Cyclobutrifluram | | | | | | | | | |
| Suspension Seed | | | | | | | | | |
| Coating Agent | | | | | | | | | |
| 20% Ipconazole | 1:1000 | 4.52 | 72.42 | 0.86 | 77.94 | 16.75 | 66.00 | 6.82 | 65.19 |
| Suspension Seed | | | | | | | | | |
| Coating Agent | | | | | | | | | |
| 15% Carbendazim• | 1:1000 | 11.14 | 32.08 | 2.46 | 37.02 | 39.30 | 20.22 | 14.94 | 23.73 |
| Thiram Suspension | | | | | | | | | |
| Seed Coating Agent | | | | | | | | | |
| Blank Control | — | 16.40 | — | 3.90 | — | 49.27 | — | 19.58 | — |

The results of field experiment showed that cyclobutrifluram and ipconazole had a significant control effect on wheat stem base rot disease, and the control effect was significantly better than that of carbendazim·thiram suspension seed coating. The pesticide formulation formed by the combination of synergistic ratios had a better overall control effect on wheat stem base rot disease, and the control effect was higher than that of a single agent. According to field investigations, within the experimental dose range, crop growth was normal, and no plant damage or abnormal phenomena were observed, which was safe for wheat.

### Embodiment 4: Field Control Experiment of Cyclobutrifluram and Ipconazole on Soybean Fusarium Root Rot

The experiment used suspension seed coating agent for soybean seed coating treatment, and the experimental soybean variety was “Wandou 37”. The experiment was conducted at the experimental base of the Anhui Academy of Agricultural Sciences. The formulation was applied to seeds at a ratio of 1:2000 by weight for seed coating without the need for dilution with water, applied directly to the seeds. After coating, the soybean seeds were naturally air-dried and then sown. Emergence rate, plant height, root length, fresh weight, and disease control efficacy were assessed 20 days post-planting, while disease control efficacy was evaluated 40 days post-planting (Table 4).

TABLE 4
Effects of different seed coating formulations on soybean growth
and control of soybean Fusarium root rot in the field

| | | | | | | | Disease |
|---|---|---|---|---|---|---|---|
| | | 20 days post-planting | | | | | control |
| | Agent | | | | | Disease | efficacy 40 |
| | solution | | Plant | | | control | days |
| | (g):Seeds | Emergence | height | Root length | Fresh weight | efficacy | post-planting |
| Agent treatment | (g) | rate (%) | (cm) | (cm) | (g) | (%) | (%) |
| 22% | 1:2000 | 90.2 | 17.8 ± 1.2 | 15.9 ± 2.1 | 3.19 ± 0.24 | 95.5 | 90.6 |
| Cyclobutrifluram• | | | | | | | |
| Ipconazole Microcapsule | | | | | | | |
| Suspension Seed Coating | | | | | | | |
| Agent | | | | | | | |
| 45% Cyclobutrifluram | 1:2000 | 91.4 | 19.2 ± 1.2 | 16.5 ± 1.8 | 3.25 ± 0.27 | 88.7 | 78.2 |
| Suspension Seed Coating | | | | | | | |
| Agent | | | | | | | |
| 20% Ipconazole | 1:2000 | 86.4 | 16.8 ± 0.8 | 14.6 ± 2.0 | 3.47 ± 0.41 | 89.4 | 76.3 |
| Suspension Seed Coating | | | | | | | |
| Agent | | | | | | | |
| 15% Carbendazim- | 1:2000 | 78.3 | 17.4 ± 1.3 | 15.5 ± 1.6 | 2.84 ± 0.22 | 68.7 | 43.7 |
| Thiram Suspension Seed | | | | | | | |
| Coating Agent | | | | | | | |
| Blank Control | — | 70.2 | 16.8 ± 1.5 | 14.9 ± 1.7 | 2.63 ± 0.31 | — | — |

The results of field experiment showed that the suspension seed coating agents composed of cyclobutrifluram and ipconazole, whether used individually or in combination, significantly improved soybean emergence rates, while having insignificant effects on plant height, root length, and fresh weight. This outcome suggests that the seed coating agents effectively mitigate seed-borne disease incidence, thereby reducing the occurrence of non-emergence due to seed infections The results also indicate that seed coating agents can reduce the inability of soybean seeds to emerge due to disease, effectively reducing seed borne diseases. Both individual and combined formulations of cyclobutrifluram and ipconazole displayed evident overall control against soybean Fusarium root rot, with the 22% cyclobutrifluram·ipconazole microcapsule suspension seed coating agent proving particularly efficacious, attributed partly to its controlled-release properties which rendered more pronounced control effects over time. According to field investigations, within the experimental dose range, crop growth was normal, and no plant damage or abnormal phenomena were observed, which was safe for soybeans.

Lastly, it is noteworthy that the embodiments listed above merely represent several specific embodiments of the present disclosure. Evidently, the disclosure is not confined to these embodiments alone, but admits numerous variations. All modifications that those skilled in the art can directly derive or infer from the content disclosed herein fall within the scope of protection of this disclosure.

What is claimed is:

1. A fungicidal composition for preventing and controlling root rot diseases in crops caused by Fusarium spp., wherein an active ingredient is composed of cyclobutrifluram and ipconazole, with a mass ratio of 20:1 to 1:20 for cyclobutrifluram and ipconazole.

2. The fungicidal composition of claim 1, wherein a mass ratio of cyclobutrifluram and ipconazole is 3:1 to 1:5.

3. The fungicidal composition of claim 1, wherein the active ingredient accounts for 1% to 80% of a total mass of the fungicidal composition, and is prepared into suspension seed coating agents, suspension agents, wettable powders, microcapsules or water dispersible granules by adding an appropriate amount of agricultural fungicidal additives.

4. A use of the fungicidal composition of claim 1 for preventing and controlling crop diseases.

5. The use of claim 4, wherein the suspension seed coating agents are used for early and efficient control of crop root rot caused by Fusarium spp., and other formulations of the composition can be applied to control diseases caused by common fungi and nematodes in crops.
